(19) United States
(12) Patent Application Publication
(10) Pub. No.: US 2003/0167198 A1
(43) Pub. Date: Sep. 4, 2003

(54) Identifying potential business opportunities

(76) Inventors: Michael B. Northcott, Vancouver, WA (US); Richard Staples, Windham, NH (US); Joshua Nathan, Belmont, MA (US)

Correspondence Address: HEWLETT-PACKARD COMPANY, Intellectual Property Administration, P.O. Box 272400, Fort Collins, CO, 80527-2400, US

(21) Appl. No.: 10/081,268

(22) Filed: Feb. 22, 2002

(51) Int. Cl. G06F 17/60

(52) U.S. Cl. 705/10

(57) ABSTRACT

A process that enables markets to be scanned quantitatively for new product opportunities based upon the identification of one or more target customer needs is described. The identified target customer needs may be qualified, and one or more of the qualified target customer needs may be used to stimulate the generation of leads for new product concepts. In one aspect, a target customer need state is identified based upon an analysis of marketplace data. A map of a process for addressing the identified target customer need state is generated. The process map includes a network of tasks each having one or more associated values. A potential point of intervention in the process is identified based at least in part upon an analysis of the values associated with the tasks in the process map.

### TECHNICAL FIELD

This invention relates to methods of identifying potential business opportunities.

### BACKGROUND

When it becomes necessary for a business to develop new products, or to reposition existing products to expand its markets, a systematic method of market assessment and product concept qualification is essential. This is especially true in businesses in which diverse information and knowledge resources are available, but no comprehensive system of leveraging them exists. In such environments, it is highly desirable to have a model for scanning the marketplace for opportunities, and a subsequent approach for validating the concepts which arise out of the scanning process.

### SUMMARY

The invention features a process that enables markets to be scanned quantitatively for new product opportunities based upon the identification of one or more target customer needs. The identified target customer needs may be qualified, and one or more of the qualified target customer needs may be used to stimulate the generation of leads for new product concepts.

In one aspect, the invention features a method of identifying potential business opportunities. In accordance with this inventive method, a target customer need state is identified based upon an analysis of marketplace data. A map of a process for addressing the identified target customer need state is generated. The process map includes a network of tasks each having one or more associated values. A potential point of intervention in the process is identified based at least in part upon an analysis of the values associated with the tasks in the process map.

Embodiments of the invention may include one or more of the following features.

The step of identifying a target customer need state may comprise scanning marketplace data without foreknowledge of a potential target customer need state. Alternatively, the step of identifying a target customer need state may comprise scanning marketplace data in accordance with a preselected target customer need state. The identified target customer need state may correspond to a customer need state that is associated with a relatively high total cost.

In some embodiments, the step of identifying a target customer need state comprises selecting a subset of potential target customer need states and associating a set of one or more tasks with each potential target customer need state. Values may be assigned to the tasks associated with each of the potential target customer need states. For example, in one embodiment, values for one or more of the following task parameter metrics are assigned to the associated tasks: a cost metric, an incidence rate metric, and a metric measuring diversity of association with different potential target customer need states. Potential target customer need states may be ranked in accordance with values assigned to associated tasks.

In some embodiments, the step of generating a map of a process for addressing the identified target customer need state comprises identifying a representative process currently addressing the identified target customer need state and generating a map for the representative process. Unit cost values, incidence rates, total costs, and outcomes for each task in the process map may be estimated. The step of identifying a potential point of intervention may comprise selecting a potential target task from the tasks in the representative process map based at least in part upon one or more of the estimated unit cost values, incidence rates, total costs, and outcomes. The potential target task may be mapped into a network of one or more sub-tasks. A list of one or more projected customer problems may be generated based at least in part upon the potential target task mapping. A list of one or more projected customer needs may be generated based at least in part upon the projected customer problem list. The step of generating the projected customer needs list may comprise identifying customer needs that correspond to business opportunities for reducing cost or improving outcomes, or both. In some embodiments, customer value associated with each of the projected customer needs is assessed. The step of generating the projected customer needs list may comprise identifying customer needs associated with specific tasks and focused on reducing cost or improving outcomes, or both.

In some embodiments, projected customer needs are correlated with core competencies and resources. One or more target projected customer needs that are well-correlated with core competencies and resources may be selected for further investigation. Unselected target projected customer needs may be stored for later review.

Other features and advantages of the invention will become apparent from the following description, including the drawings and the claims.

### DESCRIPTION OF DRAWINGS

FIG. 1 is a diagrammatic view of a customer need state driving a response from a business marketplace.

FIG. 2 is a flow diagram of a method of identifying new business opportunities.

FIG. 3 is a flow diagram of a method of identifying a target customer need state.

FIG. 4A is a flow diagram of a method of identifying a target customer disease state based upon a scan of marketplace data without foreknowledge of any potential target customer disease state.

FIG. 4B is a flow diagram of a method of identifying a target customer disease state based upon a scan of marketplace data in accordance with a preselected target customer disease state.

FIG. 5 is a map of a representative market response to an identified target customer need state.

FIG. 6A is a map of a representative market response to an identified customer need state corresponding to a clinical treatment pathway for the stroke disease state.

FIG. 6B is a map of an additional clinical treatment pathway in the process map of FIG. 6A.

FIG. 7 is a flow diagram of a method of identifying a potential intervention point in a representative market response process.

FIG. 8 is a flow diagram of a method of identifying a potential intervention point in the medical marketplace response process maps of FIGS. 6A and 6B.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

The following description relates, in one aspect, to a general process of identifying new business opportunities and, in another aspect, to an illustrative implementation of the general process as applied to the medical marketplace. In this description the concept of a “customer need state” is introduced. As used herein, the term “customer need state” refers broadly to a mode or condition of an entity that expresses a desire for supply of or relief from something. The concept of a “disease state”—which corresponds to the customer need state as applied to the medical marketplace—also is introduced. As used herein, a disease state is defined under the conceptual framework of “disease management,” which refers to an approach to healthcare delivery that emphasizes the complete structure of treatment of a given disease state, including coordinating necessary resources to smooth the episodic spikes in cost and severity of a disease.

I. Overview

A. General Approach

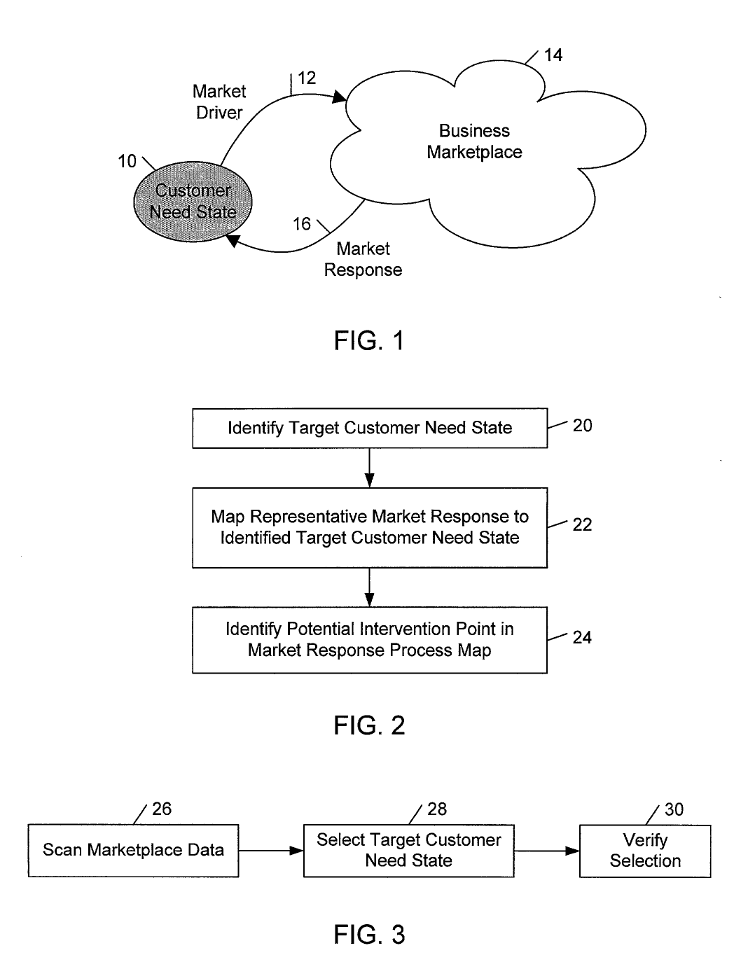

Referring to FIG. 1, a customer need state 10 impresses a collection of one or more associated needs 12 upon the business marketplace 14 to provoke a market response 16, which addresses some or all of the collection of needs 12. In particular, the business marketplace 14 responds to the collection of needs 12 with one or more processes, each of which includes a network of one or more tasks for addressing various aspects of the customer need state. In general, multiple customer need states will impress simultaneously upon business marketplace 14 a plurality of needs, some of which may overlap in terms of marketplace response processes for addressing those needs. The economic forces set into motion by any given customer need state may depend upon a wide variety of different factors, including the ability of the business marketplace to identify the customer need state, the particular set of resources that can be brought to bear on the needs impressed by the customer need state, and the relative economic value perceived by the business marketplace to be implicated by the customer need state.

As shown in FIG. 2, one or more new business opportunities may be identified by focusing upon customer need states, which contrasts with the conventional reliance upon the evolution of technology as the source of inspiration for new business opportunities. In one embodiment, new business opportunities may be identified as follows. A target customer need state is identified (step 20). A map of a process for addressing the identified target customer need state is generated (step 22). The process map corresponds to a representative market response to the identified target customer need state and typically includes a network of tasks (or workflows) each of which may be assigned one or more associated values. A potential point of intervention in the market response process map is identified based at least in part upon an analysis of the values associated with the tasks in the process map (step 24). As explained in detail below, the potential point of intervention may be explored for one or more well-defined target customer needs that may stimulate the generation of leads for new product concepts.

B. Identifying New Business Opportunities in the Medical Marketplace

In one application of the above-described general process to the medical marketplace, a Hewlett Packard Medical Supplies (HPMS) scanning process has been developed that employs quantitative and qualitative techniques to scan and define customer needs in the medical market for development into new product or business opportunities. The HPMS scanning process is defined along the conceptual framework of disease management. Disease management is an approach to healthcare delivery which emphasizes the complete structure of treatment of a given disease state, including coordinating necessary resources to smooth the episodic spikes in cost and severity of the disease. The scanning process segments the medical market by disease state, instead of technology.

The scanning process consists of two major components: a quantitative section which utilizes medical marketplace databases and other secondary data; and a qualitative portion which is designed to detail and validate the disease states discovered in the quantitative analysis. The quantitative section of the process involves a multi-hierarchical scan of the medical marketplace database until a suitable disease state is uncovered. At this point, additional data is used to qualify the disease state in terms of worldwide viability, outcomes, related medical and surgical procedures and the outpatient environment.

In some embodiments, the quantitative component of the medical market scanning process utilizes a commercially obtained database (e.g., the HCIA databases available from HCIA, Inc. of Baltimore, Md., U.S.A.), which includes complete incidence, cost, outcomes and demographic information for any given inpatient diagnosis or procedure in the U.S. for a given year. The database is organized by ICD-9 codes, and is constructed in a disease state hierarchy. It can be scanned at multiple levels of detail for disease states with high cost and incidence, which are then verified according to outcomes, procedures, outpatient data and worldwide trends. It is noted that although U.S. data includes a great deal of detailed disease information (occurrence, cost, demographics, etc.), worldwide data is not as readily available and is often in the form of “cause of death” instead of frequency of diagnosis. This limitation of the data could potentially skew interpretations. Therefore, cause of death information is used in a supporting function, rather than primary analysis.

Once the disease state is qualified (step 20), the qualitative process (steps 22 and 24) begins. Customers, clinicians, and primary and secondary research are involved to further refine the understanding of the disease state and to develop knowledge regarding the customer needs surrounding its treatment. The qualitative analysis of the medical market scanning process involves direct clinician contact in mapping the clinical pathways for the selected disease state and selecting a potential intervention point for more detailed study. When the intervention point is mapped in detail, all of the data, primary research and secondary information are gathered for a “wallowing” stage. Wallowing involves becoming immersed in the accumulated information about the selected disease state and making the creative leaps necessary to identify problems in the treatment process to which to associate customer needs. Customer needs then are qualified through more contact with clinicians and customers.

The product of the qualitative component and of the medical market scanning process as a whole is a short list of well-defined, qualified customer needs. This list is used to initiate a HPMS Pre-phase 0 process of screening the customer needs, making business proposals and allocating resources for a Phase Review Product Generation Process.

II. Identifying a Target Customer Need State

A. General Approach

Referring to FIG. 3, in one embodiment, a target customer need state may be identified as follows. Initially, marketplace data is scanned (step 26). Such marketplace data may be publicly available data (e.g., data that is published by governmental entities, industry trade groups and professional research companies, such as Gartner Group, Inc., International Data Corporation and RoperASW) or is privately held data (e.g., data collected over time by one or more business entities). The data may include the cost of procedures associated with various customer need states, the incidence rate of such customer need states, and data relating various customer need states to each other (e.g., identification of procedures or tasks that are implicated by multiple customer need states). The marketplace data may be scanned with or without foreknowledge of a potential target customer need state.

After the marketplace data has been scanned (step 26), a target customer need state is selected (step 28). The selected target customer need state may correspond, for example, to a customer need state that is associated with a relatively high total cost. During the selection process (step 28), a subset of potential target customer need states may be selected and a respective set of one or more tasks (or procedures) may be associated with each of the potential target customer need states. The tasks associated with a given potential target customer need state may correspond to one or more aspects of the business marketplace response 16 to that potential target customer need state. Values may be assigned to the tasks associated with each of the potential target customer need states. The values may correspond to one or more of the following tasks parameter metrics: a cost metric, an incidence rate metric, and a metric measuring diversity of association with different potential target customer need states. The potential target customer need states may be ranked in accordance with the values assigned to the associated tasks. The highest ranking potential target customer need state may be selected as the target customer need state.

After the target customer need state has been selected (step 28), this selection is verified (step 30). The selection of the target customer need state may be verified based upon an analysis of worldwide viability, outcomes and other factors, such as diversity of association with different customer need states or business marketplace responses.

B. Identifying a Target Customer Need State in the Medical Marketplace

1. Overview of the Process

a) Objectives

The overall objective of the scanning process is to systematically generate leads for new product and service business concepts. It is critical that the needs and desires of the customer be integrated into the concept generation process, therefore scanning must address or define the problems customers face in the treatment of diseases.

b) Existing Market Segmentation Methods

Existing methods of market segmentation and product concept generation in the medical marketplace are across two dimensions. The horizontal dimension (rows) is represents technology or medical/surgical procedures (e.g., Ultrasound, ECG, Defibrillation, Monitoring). The vertical dimension (columns) is segmented by disease state (e.g., Circulatory, Digestive, Respiratory, Nervous). The traditional method of market segmentation has been along the horizontal dimension, with technology as the driver. The HPMS scanning process segments initially along the vertical dimension, focusing instead on disease states. Projected customer needs are then validated by cross-correlating the vertical and the horizontal dimensions (see below for a representation of the row/column matrix).

| | | Disease State | | | |
|---|---|---|---|---|---|
| | | | | Respi- | |
| | | Circulatory | Digestive | ratory | Nervous |
| Technology | Ultrasound | + | + | + | − |
| (Procedure) | | | | | |
| | ECG | + | − | − | − |
| | Defib | + | − | − | − |
| | Monitoring | + | + | + | + |

Two-dimensional market segmentation model, where “+” indicates technology which is used in treatment or diagnosis of example disease, and “−” indicates no such intersection.

c) Disease Management Approach

As mentioned above the HP Medical Supplies scanning process relies upon the concept of disease management. The goal of disease management is to smooth the traditionally jagged cost curve of a patient's life with a disease by anticipating the cost spikes (which correspond to critical episodes) and intervening proactively, thereby reducing overall costs of care. The HCIA database which forms the initial stage of the scanning process has been constructed within the framework of disease states. By aligning the scanning process with a major emerging trend in healthcare delivery, the perspective of the customer is involved at the very front end of the process.

Another advantage of organizing the conceptual framework of the scanning process around disease states is that the qualitative component of the process may be built around the clinical pathway for the specified disease state. The clinical pathway is the typical treatment route for one who is afflicted by a given disease. The goal of the clinical pathway is to catalog “best practices” of disease treatment to ensure consistency and quality of care, and to reduce superfluous treatments. The concept of clinical pathways (i.e., explicit maps of the typical chains of treatment treatments for a given disease or condition; also known as critical pathways and best practices) is integrated into the scanning process, which generally involves primary research. This again has placed the scanning process in the perspective of the customer, and often provides direct contact with clinicians at the early stage of the process.

In addition to focusing directly on disease states and treatments specific to those diseases, treatments and procedures that may appear across several disease states also are considered during the scanning process, especially in the diagnostic and monitoring arenas.

2. The Medical Scanning Process

a) Data Sources

The front end of the scanning process uses a commercial database (e.g., the National Inpatient Profile (NIP), provided by HCIA, Inc., of Baltimore, Md., U.S.A.). The database consists of frequency, cost and demographic information for every inpatient diagnosis and procedure in the United States for a given year. The data is categorized by ICD-9 code, and is developed by examining public Medicare and Medicaid, hospital and private insurer records. According to HCIA, the database contains “9 million all-payor discharges . . . representing more than 25 percent of all discharges from all U.S. STGNF [short-term, general, non-federal] hospitals” (see HCIA National Inpatient Profile, Diagnoses—October 1994-September 1995). An outpatient database, National Outpatient Profile (NOP), is also available, but the data is less consistent than the inpatient. Nonetheless, such outpatient data may be used for secondary qualification.

Although the HCIA data are consistent and detailed, the U.S. market constitutes only about half of the worldwide medical market. Accordingly other sources of data are necessary to qualify trends and observations identified in U.S.-only data. Medistat, a series of country-specific medical market profiles, published by WMI Publications of Chichester, UK, provides a worldwide dimension to the data analysis. However, the formats of Medistat's data are not consistent from country to country, and they cannot be relied upon as principal sources. They may serve as secondary filters to globalize observations generated by the HCIA data.

Other secondary sources of worldwide information are provided by the Organisation for Economic Co-operation and Development (OECD), and by a commercial source, Pharmametrics GmbH of Freiburg, Germany (primarily European data).

b) Quantitative Methodology

As indicated above, the primary tool in the quantitative component of the scanning process is the HCIA inpatient database, NIP. Since NIP is indexed by ICD-9 codes, the conceptual structure on which the coding system is based has been used to build the scanning model database. Integrated into the ICD-9 codes are layers of disease groupings, from the very broad (Disease Major Groups) to the highest level of detail available in the data (individual diagnoses).

There are four major layers of structure built into the NIP database (see below for a database example matrix):

1. Major Disease Groups

These groups encompass the major body systems (e.g., circulatory, respiratory, digestive, etc.) and correspond roughly to MDC codes used in Medicare reimbursement.

2. Intermediate Disease Groups

These groups fall within the Major Disease Groups and describe relatively broad categories of disease (e.g., ischemic heart disease, acute respiratory infections, noninfectious enteritis and colitis, etc.)

3. Minor Disease Groups

These groups are contained in the Intermediate Disease Groups and represent relatively high levels of detail (e.g., acute myocardial infarction, acute sinusitis, ulcerative colitis, etc.) Minor Disease Groups are sometimes the highest level of detail available.

4. Individual Diagnoses

Individual Diagnoses represent the highest level of detail available in the database, and add a dimension of depth to the Minor Disease Groups (e.g., AMI of inferolateral wall, acute sinusitis-sphenoidal, left-sided ulcerative colitis, etc.). The Diagnoses correspond directly to individual ICD-9 codes.

| No. | Layer Name | Example (ICD-9 Range) | | |
|---|---|---|---|---|
| 1 | Disease Major Group | Circulatory (390-459) | Respiratory (460-519) | Digestive (520-579) |
| 2 | Disease Intermediate | Ischemic Heart Disease | Acute Respiratory | Noninfectious Enteritis |
| | Group | (410-414) | Infections (460-466) | and Colitis (555-558) |
| 3 | Disease Minor Group | Acute Myocardial | Acute Sinusitis (461) | Ulcerative |
| | | Infarction (410) | | Colitis (556) |
| 4 | Individual Diagnosis | of Interferolateral Wall | Sphenoidal (461.3) | Left-Sided (556.5) |
| | | (410.2) | | |

Scanning Database Structure

c) Quantitative Scanning Approaches

There are two major approaches to the quantitative scanning process: a “naive” approach, in which the scan for market opportunities is effectively a clean slate; and an “inspired” approach, in which a lead has been generated by previous research or outside information.

(1) Naive Approach

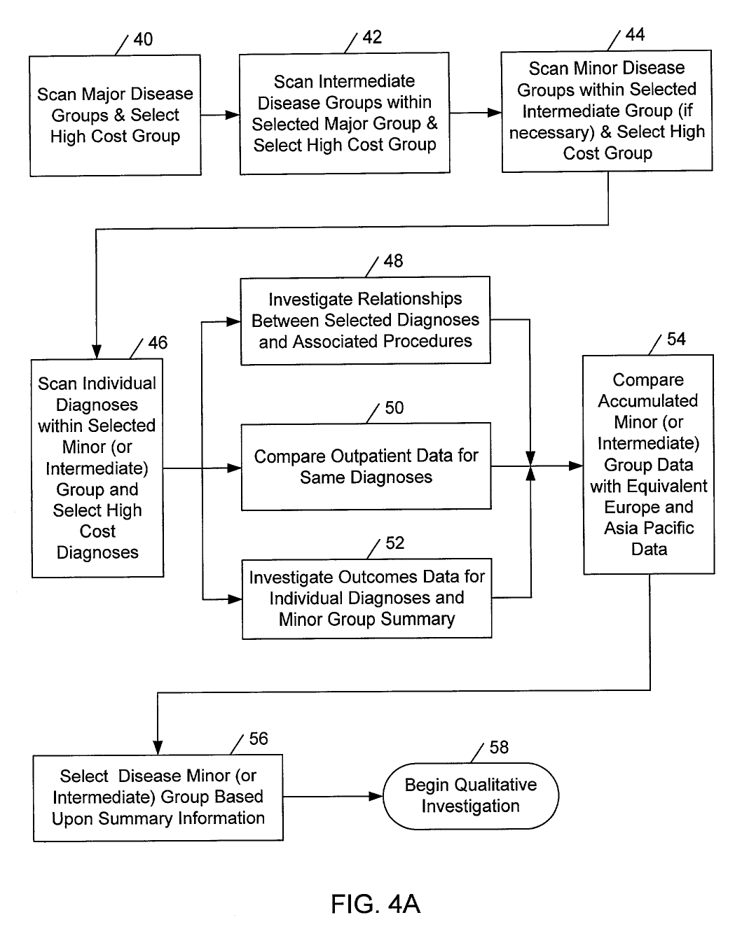

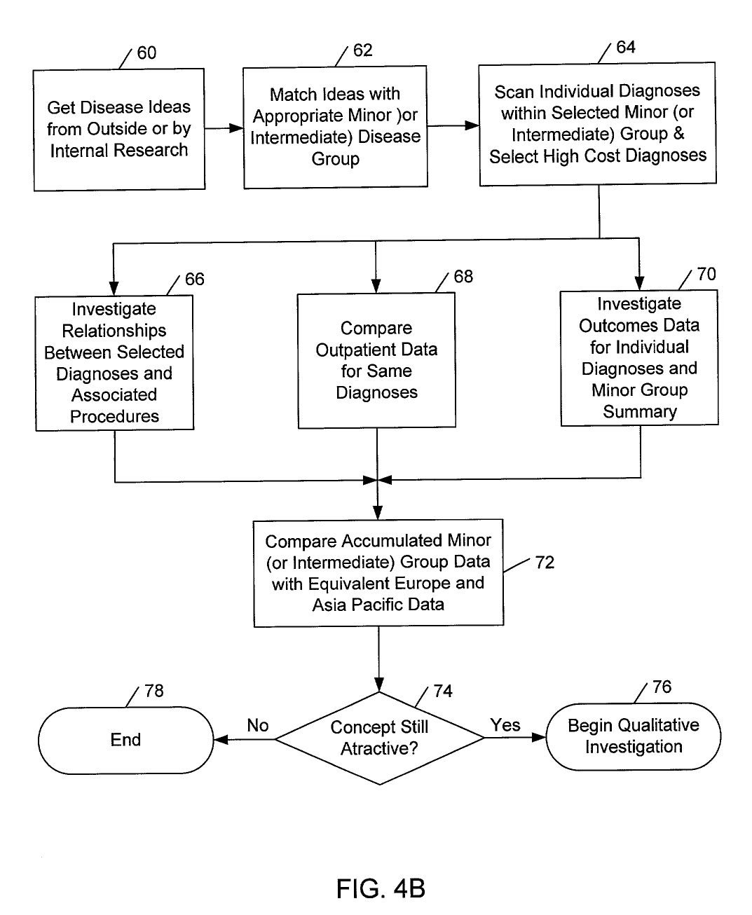

Referring to FIG. 4A, in one embodiment, the naive approach to scanning begins without prior knowledge or assumptions about the disease states to be scanned. Because the goal of the quantitative process is to generate leads to be explored qualitatively, it is necessary that the data be interpreted without bias. The process is conducted as follows:

1. Scan Major Disease Groups for cost and incidence (step 40). Rank the groups according to total cost (cost*incidence) and select at least one group with high cost and high incidence.

2. Scan Intermediate Disease Groups within selected Major Disease Groups for cost and incidence (step 42). Rank the groups according to total cost (cost*incidence) and select at least five from each selected Major Disease Group with high cost and high incidence.

3. Scan Minor Disease Groups within selected Intermediate Disease Groups for cost and incidence (step 44). Rank the groups according to total cost (cost*incidence) and select at least five from each selected Intermediate Disease Group with high cost and high incidence. This level of detail will sometimes be unnecessary, depending on the specificity of the Intermediate Groups.

4. Scan Individual Diagnoses within selected Minor Disease Groups for cost and incidence (step 46). Rank the diagnoses according to total cost (cost*incidence) and select at least five from each selected Minor Disease Group with high cost and high incidence. If paragraph 3 (step 44) was skipped, investigate the top 5-10 diagnoses in the selected Intermediate Groups.

5. Within each Individual Diagnosis, identify the links to Individual Procedures, and explore the procedure data hierarchy (step 48). In general, HCIA Procedure data has a hierarchy similar to Diagnosis data. Procedure data can be understood in terms of Major Procedure Groups, Intermediate Procedure Groups, Minor Procedure Groups and individual procedures. Links to diagnoses exist only at the individual level. Rank the procedures according to frequency of occurrence in the diagnosis and total cost (cost*incidence). Check for procedures which are themselves linked to diverse diagnoses. Links exist from diagnoses to procedures, as well as procedures to diagnoses. Weight the importance of diagnoses with links to procedures with high cost, volume and diversity more heavily. Regroup Individual Diagnoses into their respective Minor (or Intermediate) Disease Groups, check the aggregate procedure link information for each Minor (or Intermediate) group and rank the Minor (or Intermediate) Groups according to the aggregates. Reject Minor (or Intermediate) Groups with weak links.

6. Investigate Individual Diagnoses within selected Minor (or Intermediate) Disease Groups for relative incidence rankings within HCIA's NOP database from the previous year (step 50). The NOP database does not contain comprehensive diagnosis cost information and is published one year later than the NIP. Assign greater overall weight to Minor (or Intermediate) Groups with high outpatient incidence rates.

7. Evaluate outcome information for Individual Diagnoses within selected Minor (or Intermediate) Disease Groups (step 52). Weight more heavily Minor (or Intermediate) Groups which contain high cost, high incidence, poor outcome (high mortality) diagnoses. Reject Minor (or Intermediate) Groups with excellent outcomes and low cost. In some cases, it may be helpful to create numerical indices for to assist in evaluation of diagnoses and their relationships to procedures, outpatient data and outcomes.

8. Once Disease Minor (or Intermediate) Groups have been successively filtered by procedure links, outpatient data and outcomes data (steps 48, 50, 52), compare remaining Minor (or Intermediate) Groups to available European and Asian data from Medistat publications, or other sources (step 54). Where possible, check that there is significant incidence of the selected Minor (or Intermediate) Group.

9. Select one or more remaining Minor (or Intermediate) Disease groups for qualitative analysis based on final cost rank (steps 56 and 58).

Throughout the quantitative process, it should be assumed that the user will exercise judgment regarding the disease states explored in the model. Although this is a “naive” application, one should not abandon sound business judgment in selecting areas to explore.

(2) Inspired Approach

Referring to FIG. 4B, in one embodiment, the Inspired approach to medical market scanning requires that the user have a predetermined disease in mind when performing the quantitative analysis. The Inspired process of verifying the lead is largely identical to the Naive approach.

The process is conducted as follows:

1. Target a disease state based on outside or internal research (step 60). Inspiration can come from any number of sources, including: journal articles, discussions with customers or clinicians, news reports or other personal experiences.

2. Refer to ICD-9 lists to determine the appropriate diagnoses, and match to the correct Minor (or Intermediate) Disease Group (step 62).

3-7. Steps 66, 68, 70 and 72 are the same as steps 48, 50, 52 and 54 in the naive approach described above, except that the goal is to verify the quantitative weight of the targeted Minor (or Intermediate) Group, instead of ranking a collection of Minor (or Intermediate) Groups.

8. If after passing through filtering steps 66-72, the targeted Minor (or Intermediate) Group still seems to have potential (step 74), begin the qualitative component of the scanning process (step 76). If it is no longer attractive, end the Inspired approach for the targeted disease state (step 78).

3. Example of HPMS Scanning process

To assist in the development and to test the validity of the scanning process, HPMS undertook a sample scan. The Inspired approach was employed, and the details of the scanning process were developed as the example took shape.

a) Quantitative Scan-Inspired Approach

In the case of this example, the targeted disease state was inspired by conversations with a clinician who recommended the study of stroke, specifically because of newly approved treatments which have greatly improved victims' outcomes, and because it is the third most common cause of death in the U.S. The Inspired approach was initiated to verify the market strength of Stroke. By using the database, the following observations were made (where applicable, the following paragraphs are numbered according to the corresponding paragraphs in the Inspired process described above):

2. Because the Minor Disease Groups related to stroke have a high degree of specificity, the Intermediate Group, Cerebrovascular Disease (430-438) was chosen as the Disease state for investigation. This Intermediate Group captures the specific diagnosis for stroke (CVA) as well as the immediate, direct causes of stroke. Understanding these relationships is the critical to Disease Management.

The total inpatient incidence of principal diagnoses of the Disease state in 1994 was 774,829 cases, with a total hospital cost of $8,576,455,331. Because HCIA's data focuses on costs of principal diagnoses, secondary diagnosis data is not considered.

3. A sample of the top diagnoses (ranked by total cost) in the Intermediate Group is as follows:

| | ICD-9 | | Principal | | |
|---|---|---|---|---|---|
| Rank | Code | Description | Incidence | Total Cost | Average Unit Cost |
| 1 | 434.91 | Cerebral artery occlusion with | 199413 | 2172453911 | 10894 |
| | | infarction | | | |
| 2 | 431 | Intracerebral hemorrhage | 56882 | 1016962441 | 17878 |
| 3 | 430 | Subarachnoid hemorrhage | 22920 | 952792360 | 41570 |
| 4 | 436 | Cerebrovascular accident (CVA) | 111474 | 935102755 | 8388 |
| 5 | 433.1 | Carotid artery occlusion, no | 74330 | 788360500 | $10,606 |
| | | infarction | | | |

4. A sample of procedures linked to top diagnoses is as follows

| Diagnosis | | | Linked Procedures | | | |
|---|---|---|---|---|---|---|
| | ICD-9 | | ICD-9 | | | Freq in |
| Rank | Code | Description | Code | Description | Occur | Diagnosis |
| 1 | 434.91 | Cerebral artery | 87.03 | CAT scan of head | 57315 | 0.2 |
| | | occlusion with | 88.72 | Dx ultrasound-heart | 20850 | 0.1 |
| | | infarction | 88.71 | Dx ultrasound-head/neck | 19838 | 0.1 |
| | | | 88.91 | MRI, brain & brain stem | 16432 | 0 |
| 2 | 431 | Intracerebral | 87.03 | CAT scan of head | 17716 | 0.3 |
| | | hemorrhage | 96.04 | Insert endotrachial tube | 8729 | 0.1 |
| | | | 96.71 | Continuous mechanical | 7926 | 13.9% |
| | | | | ventilation <96 hours | | |
| | | | 88.41 | Contrasting cerebral | 4561 | 0 |
| | | | | arteriogram | | |
| | | | 1.39 | Other brain incision | 4348 | 0 |
| | | | 96.72 | Continuous mechanical | 4176 | 0 |
| | | | | ventilation >95 hours | | |
| | | | 88.91 | MRI, brain & brain stem | 3294 | 0 |
| | | | 43.11 | Percutaneous gastrostomy | 3285 | 0 |
| 3 | 430 | Subarachnoid | 88.41 | Contrasting cerebral | 13648 | 0.6 |
| | | hemorrhage | | arteriogram | | |
| | | | 39.51 | Clipping of aneurysm | 9192 | 0.4 |
| | | | 87.03 | CAT scan of heat | 5987 | 0.2 |
| | | | 96.04 | Insert endotrachial tube | 5501 | 0.2 |
| | | | 96.71 | Continuous mechanical | 4267 | 0.1 |
| | | | | ventilation <96 hours | | |
| | | | 3.31 | Spinal tap | 3945 | 0.1 |
| | | | 2.2 | Ventriculostomy | 3944 | 0.1 |
| | | | 96.72 | Continuous mechanical | 3596 | 0.1 |
| | | | | ventilation >95 hours | | |
| | | | 38.93 | Venous catheter, NEC | 3088 | 0.1 |
| | | | 1.18 | Other brain Dx procedure | 2920 | 0.1 |
| 3 | 430 | Subarachnoid | 89.64 | Pulmonary artery wedge | 2130 | 0 |
| | | hemorrhage (cont.) | | monitor | | |
| | | | 38.91 | Arterial catheterization | 1737 | 0 |
| | | | 2.34 | Ventricular shunt - | 1466 | 0 |
| | | | | abdomen | | |
| | | | 96.6 | Enteral nutrition | 1358 | 0 |
| | | | 31.1 | Temporary tracheostomy | 1232 | 0 |

Since this exemplary Inspired process evaluates only one Minor Group, it is not necessary to rank procedure links to discriminate between multiple Minor Groups.

A sample of links from procedures back to diagnoses follows:

| Procedure | | Linked Diagnosis | | | |
|---|---|---|---|---|---|
| ICD-9 Code | Description | ICD-9 Code | Description | Occur | Freq in Procedure |

| | | | | | |
|---|---|---|---|---|---|
| 1.39 | Other brain | 431 | Intracerebral | 4173 | 0.4 |
| | incision | | hemorrhage | | |
| | | 401.9 | Hypertension | 2941 | 0.3 |
| | | | NOS | | |
| | | 342.9 | Hemiplegia NOS | 1709 | 0.1 |
| | | 276.1 | Hyposmolality | 1038 | 0.1 |
| | | 780.3 | Convulsions | 932 | 0.1 |
| | | 331.4 | Obstructive | 928 | 0.1 |
| | | | hydrocephalus | | |
| | | 599 | Urinary tract | 926 | 0.1 |
| | | | infection NOS | | |
| | | 276.8 | Hypopotassemia | 923 | 0.1 |
| | | 432.1 | Subdural | 921 | 0.1 |
| | | | hemorrhage | | |
| | | 427.31 | Atrial fibrillation | 759 | 0 |
| | | 518.81 | Respiratory | 725 | 0 |
| | | | failure | | |
| | | 285.9 | Anemia NOS | 589 | 0 |
| | | 285.1 | Acute | 577 | 0 |
| | | | Posthemorrhagic | | |
| | | | Anemia | | |
| | | 428 | Congestive Heart | 571 | 0 |
| | | | Failure | | |
| | | 414 | Coronary | 567 | 0 |
| | | | atherosclerosis | | |
| | | E888 | Fall, NEC & NOS | 500 | 0 |
| | | 324 | Intracranial | 494 | 0 |
| | | | abscess | | |
| | | 496 | Chronic airway | 473 | 0 |
| | | | obstruction, NEC | | |
| | | 518 | Pulmonary | 472 | 0 |
| | | | collapse | | |

From this example, it is clear that one procedure, which seems limited to treatment of a specific Disease state, can appear across several disease categories. Thus, during this process, procedure links across many disease states are investigated for the possibility of identifying new business opportunities.

5. The 1993 NOP database indicates that for the selected Disease state (Intermediate Disease Group), only the following diagnoses were treated on an outpatient basis:

| | | Hospital | Non-Hospital | |
|---|---|---|---|---|
| | Diagnosis | Outpatient | Outpatient | Total |
| ICD-9 Code | Description | Visits | Visits | Visits |
| 435 | Transient | 186943 | 474334 | 661277 |
| | Cerebral | | | |
| | Ischemia | | | |
| 435.9 | Transient | 185770 | 428840 | 614610 |
| | Cerebral | | | |
| | Iscemia, NOS | | | |
| 436 | Cerebrovascular | 461110 | 768891 | 1230001 |
| | accident | | | |
| | (CVA) | | | |
| | Total | 833823 | 1672065 | 2505888 |

Although only three of the many individual diagnoses pertaining to the selected Disease state appear in the NOP, the ratio of outpatient diagnoses as a percentage of inpatient diagnoses for this condition was 323%. This ratio is significant enough to merit further investigation of the Disease state.

6. Inpatient outcomes information on the sample top diagnoses came from the NIP database:

| | ICD-9 | | Principal | | | Death | Death Rate* |
|---|---|---|---|---|---|---|---|
| Rank | Code | Description | Incidence | Total Cost | Total Deaths | Rate | Cost |
| 1 | 434.91 | Cerebral artery | 199413 | 2172453911 | 18663 | 0 | 204210667 |
| | | occlusion with | | | | | |
| | | infarction | | | | | |
| 2 | 431 | Intracerebral | 56882 | 1016962441 | 19310 | 0.3 | 344750267 |
| | | hemorrhage | | | | | |
| 3 | 430 | Subarachnoid | 22920 | 952792360 | 7068 | 0.3 | 293460046 |
| | | hemorrhage | | | | | |
| 4 | 436 | Cerebrovascular | 111474 | 935102755 | 10348 | 0 | 86964556 |
| | | accident (CVA) | | | | | |
| 5 | 433.1 | Carotid artery | 74330 | 788360500 | 338 | 0 | 3153442 |
| | | occlusion, no | | | | | |
| | | infarction | | | | | |

One measure which can provide clarity to outcomes analysis is a Death Rate*Cost (DRC) metric. This index places outcomes of diverse diagnoses into a uniform format and makes outcomes easier to compare.

Several of the sample diagnoses have relatively high DRC values of over $200,000,000 which describes a dollar amount of treatment for patients who ultimately did not benefit, and could have been used elsewhere. In the aggregate this number is undoubtedly significant. There is real opportunity to reduce cost and/or improve outcomes in this Disease state.

7. At the time of this example, worldwide data sources were not well-developed. However, the following data were available from Medistat:

| | | | | | |
|---|---|---|---|---|---|
| Country | Disease Type | Incidence | Comment | Year of Data | Population |

Europe

| | | | | | |
|---|---|---|---|---|---|
| Austria | Cerebrovascular | 51973 | Inpatient Diagnoses | 1991 | 7.9M |
| Belgium | Circulatory | 41,002 Deaths | Cause of Death | 1988 | 10.1M |
| Denmark | Circulatory | 9497 | Discharges | 1991 | 5.2M |
| Finland | Circulatory | 188795 | Patient Days/Avg Stay | 1993 | 5.1M |
| France | Cerebrovascular | 18569 | Longterm new illness | 1993 | 58M |
| | Seizure | | | | |
| Germany | Cerebrovascular | 106,631 Deaths | Cause of Death | 1992 | 81.9M |
| Greece | Circulatory | 49,450 Deaths | Cause of Death | 1991 | 10.6M |
| Ireland | Cerebrovascular | 3,072 Deaths | Cause of Death | 1993 | 3.5M |
| Italy | Cerebrovascular | 74,519 Deaths | Cause of Death | 1991 | 57.19M |
| Netherlands | Cerebrovascular | 26780 | Discharges | 1991 | |
| Norway | Cerebrovascular | 39491 | Discharges | | 4.4M |
| Portugal | Circulatory | 88392 | Discharges | 1993 | 9.9M |
| Spain | Circulatory | 304046 | Discharges | 1990 | 39.2M |
| Sweden | Circulatory | 47,651 Deaths | Cause of Death | 1992 | 8.8M |
| Switzerland | Circulatory | 14.9% | Patients in Hospital | 1990 | 7M |
| UK | Cerebrovascular | 75,847 Deaths | Cause of Death | 1992 | 58.4M |

Asia/Pacific

| | | | | | |
|---|---|---|---|---|---|
| Japan | Cerebrovascular | 377500 | No. of patients per day | 1990 | 125M |
| Australia | Circulatory | 46% | Cause of Death | 1988 | 17.7M |
| | | of Deaths | | | |
| Singapore | Circulatory | 37.1% | Cause of Death | 1990 | 2.7M |
| | | of Deaths | | | |
| China | Cerebrovascular | 23.4% | Cause of Death | 1993 | 1.15B |
| | | of Deaths | | | |
| Taiwan | Cerebrovascular | 12.2% | Cause of Death | 1994 | 21.1M |
| | | of Deaths | | | |
| Korea | Circulatory | 5338 | Treatment Cases | 1994 | 44.9M |
| New Zealand | Circulatory | 55416 | Hospital Discharges | 1992 | 3.49M |
| Malaysia | Circulatory | 82010 | Hospital Admissions | 1992 | 19.1M |
| Indonesia | Cerebrovascular | 1.3% | Hospital Morbidity | 1989/90 | 189.1M |
| | | of Discharges | | | |
| Thailand | Cerebrovascular | 35382 | Inpatients | 1992 | 5.91M |
| India | Circulatory | 19.7% | Cause of Death | 1994 | 900M |
| | | of Deaths | | | |

Source: Medistat, WMI Publications: Chichester, UK

To place in context the European and Asia/Pacific data, statistics on the U.S. from the HCIA NIP database and Medistat are as follows:

United States

| | | | Year of | |
|---|---|---|---|---|
| Disease Type | Incidence | Comment | Data | Population |
| Circulatory | 26621552 | Principal & | 1994 | 260.2M |
| | | Secondary | | |
| | | Inpatient | | |
| Cerebrovascular | 1511784 | Principal & | 1994 | 260.2M |
| | | Secondary | | |
| | | Inpatient | | |
| Circulatory | 913,400 Deaths | Cause of Death | 1994 | 260.2M |
| Cerebrovascular | 144,100 Deaths | Cause of Death | 1994 | 260.2M |

Sources: Medistat, WMI Publications: Chichester, UK and National Inpatient Profile, HCIA, Inc.: Baltimore, MD

8. Based on the original assessment and having passed through the filters in steps 66-72, the selected Disease state still appeared to be attractive (step 74). The next step was to begin the Qualitative Investigation (step 76).

III. Mapping a Market Response

A. General Approach

Before mapping a market response, a representative market response to the needs impressed by the identified target customer need state must be identified. The selected representative market response should be the predominant market process that has been established to address the identified target customer need state.

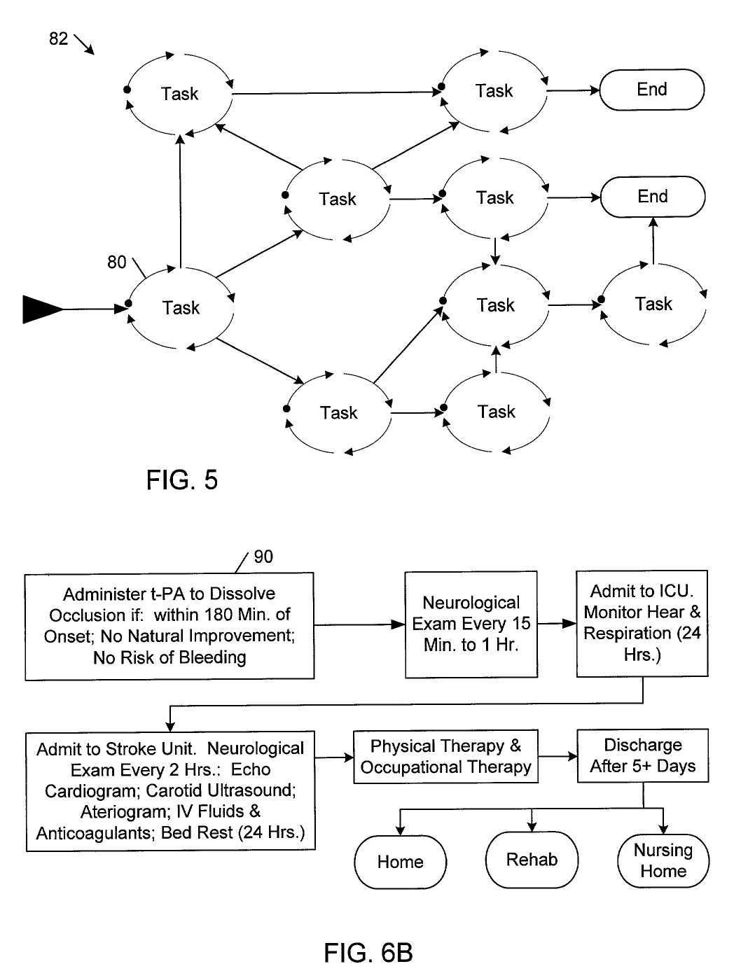

Referring to FIG. 5, in one embodiment, the process of mapping the selected representative market response to the identified target need state involves identifying the major tasks 80 (or workflows) in the selected representative market response. The selected representative market response process may be mapped using any one of a wide variety of different conventional workflow (or business process) mapping techniques. In general, the resulting process map will include a network 82 of tasks 80 to which one or more values may be assigned. The assigned values may, for example, correspond to estimates of unit cost, incidence rates, total costs, and outcomes for each task in the process map.

Based at least in part upon one or more of the estimated value parameters, a potential target task 80 may be selected. As explained in detail below, an analysis of the potential target task 82 may stimulate the identification of a potential point of intervention in the representative market response to the identified target customer need state.

B. Qualitative Methodology as Applied to the Medical Marketplace

Using either the Naive or the Inspired approach to the quantitative scan of the medical market database should yield at least one Disease Minor (or Intermediate) Group (hereafter referred to as Disease state) which can be defined and analyzed qualitatively. The qualitative component of the scanning process creates the opportunity for direct contact with customers and to refine the investigation to a level which should yield new product concepts.

Although pre-judgment of the information yielded by the quantitative component was largely avoided in the qualitative section, it becomes necessary to sort through information with a much higher degree of intuition. Another underlying assumption about this section is that the user has accumulated a competent level of personal knowledge about the selected Disease state through secondary research. Accordingly, this analysis should be performed by someone with strong medical market experience (in contrast to the quantitative section).

The qualitative analysis begins by contacting clinicians or other experts and map the typical clinical pathway for the selected disease state. This map consists of the most typical treatment path clinicians follow in incidences of the selected disease state. Some clinical pathways are available commercially. Contacts may come from personal relationships (friends, relatives), other business associations (Clinical Panel), commercial sources, (e.g., Sopheon GmbH of Frankfurt, Germany), or by approaching experts identified in secondary research or on the Internet.

C. Qualitative Analysis Example

The qualitative component of the scanning process is designed to examine the disease states indicated and verified by the quantitative process and to develop an understanding of current or potential customer needs surrounding the selected disease state. The following analysis of the example, Cerebrovascular Disease, and more specifically, stroke, will follow the qualitative methodology described above.

The clinician who made the original suggestion to study stroke was contacted, and the clinical pathway for the treatment of the condition was mapped. This information is sometimes available commercially or through secondary research; however, it is recommended to conduct primary research with clinicians wherever possible.

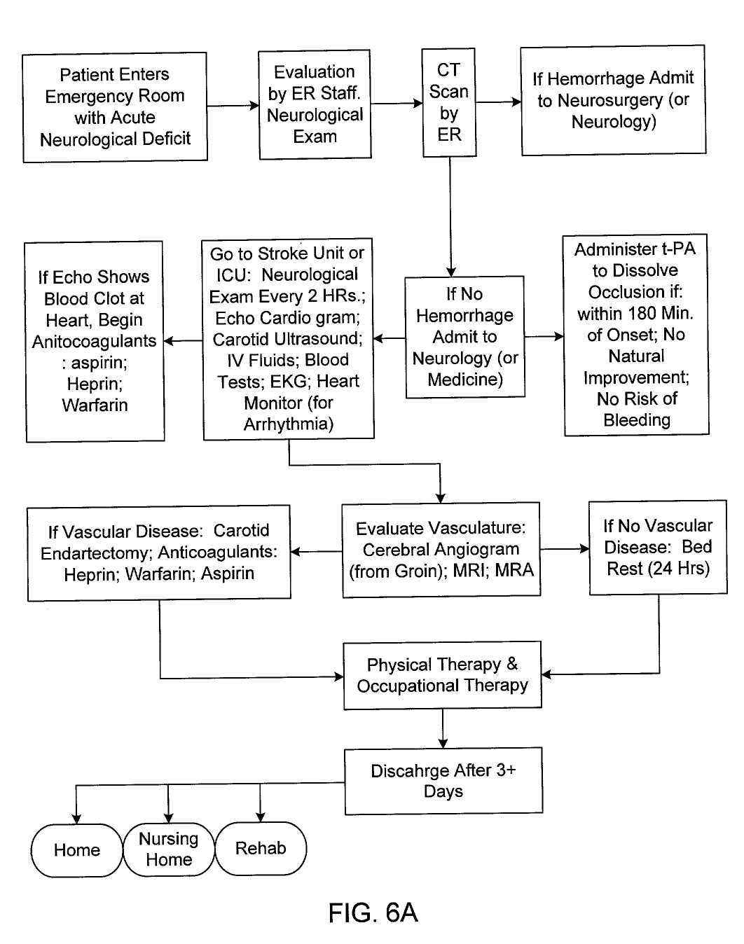

The stroke clinical pathway is show in FIGS. 6A and 6B. The clinical pathway is self-explanatory. FIG. 6A corresponds to the primary clinical pathway and FIG. 6B corresponds to a relatively new treatment branch that has been approved.

IV. Identifying a Potential Intervention Point

A. General Approach

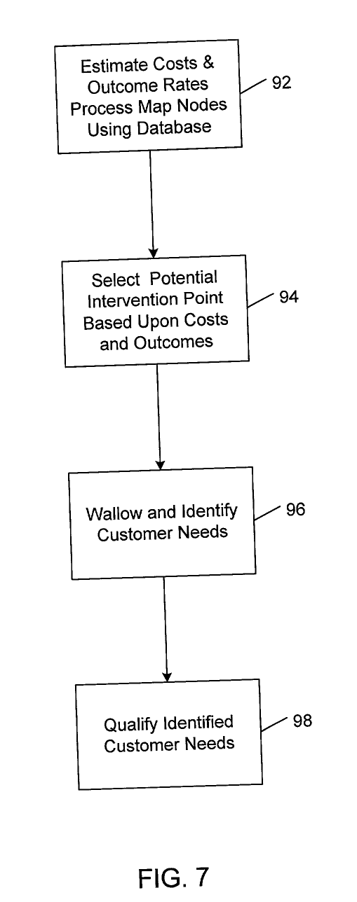

Referring to FIG. 7, in one embodiment, in one embodiment, a potential invention point may be identified as follows.

Initially, costs and outcome rates are estimated for each task (or workflow) in the representative market response process map (step 92).

Based upon the estimated cost information (step 92), a potential intervention point in the marketplace response is selected (step 94). Among the factors that may be used to guide the selection of the potential intervention point are total cost associated with the corresponding task and the developmental maturity of that task. In general, tasks associated with higher costs and less developmental maturity are preferred as potential intervention points over tasks associated with lower costs and longer developmental maturity.

Next, a wallowing process is used to identify one or more target customer needs (step 96). In this process, a user must make creative and intuitive leaps to generate a list of projected customer problems, then needs (step 106). This creative process has been called “wallowing” because it requires the user to become immersed in the qualitative details of the selected potential target task. Sometimes customers will indicate their needs clearly, but not often enough to obviate the need for wallowing. The basic question which must be answered by wallowing is, “how can the customer be assisted in the selected potential target task, either in reducing the cost or improving the outcome?” One way this can be done is by an intervention in the process map that shortens or eliminates sections of the process map. Suggestions for assisting in the Wallowing process include:

Primary Research

Brainstorming

Secondary Research

Customer Contact

Customer Observation

In some cases, the Wallowing stage requires brainstorming and repeated interaction with the clinician. A “5-Why” technique of questioning also may be used to expose root causes of customer needs.

After one or more customer needs are identified by the wallowing process (step 96), the identified customer needs are qualified (step 98). The customer needs may be qualified with actual customers. In addition, some of the primary research contacts from previous steps may be used to assess the validity of the needs and their relative importance to the customer.

B. Identifying a Potential Intervention Point in a Medical Marketplace Response

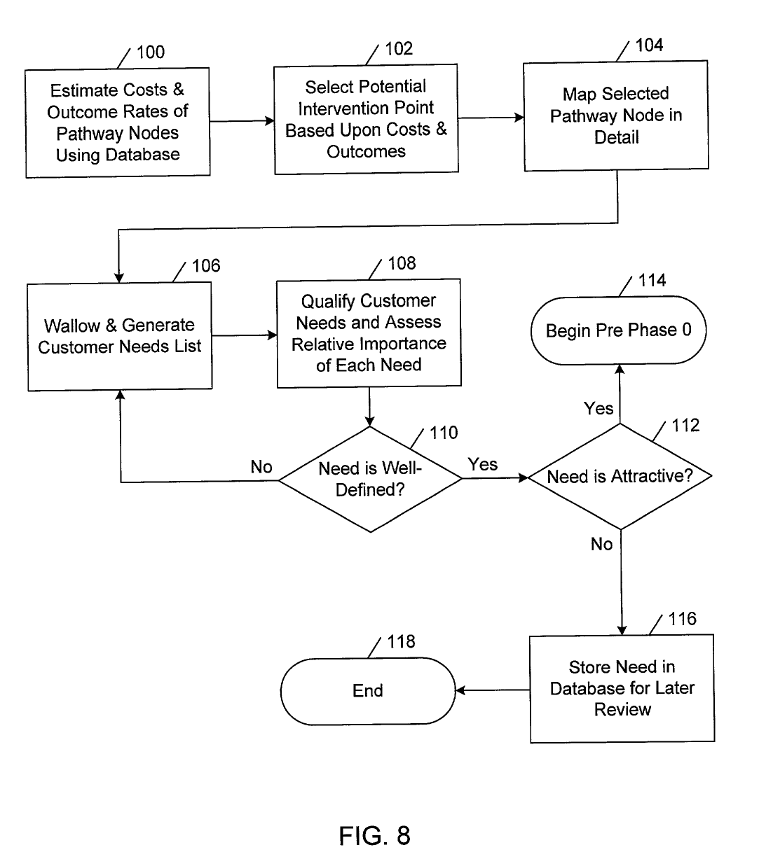

Referring to FIG. 8, using the HCIA NIP database, study the procedures which constitute major nodes of the Clinical Pathway map. Estimate unit cost, incidence, total cost and outcomes for each node (step 100). For example, using the HCIA NIP database, the following costs could be estimated for the major nodes of the clinical pathway:

| | ICD-9 | | Principal | | | |
|---|---|---|---|---|---|---|
| Node | Code | Description | Incidence | Unit Cost | Total Cost | Death Rate |
| 1 | 89.15 | Neurologic Exam | 1194 | 8312 | 9924528 | 0 |
| 2 | 88.38 | CAT Scan | 24001 | 6513 | 156318513 | 0 |
| 3 | N/A | Admit to Neurosurgery | | | 0 | |
| 4 | N/A | Admit to Neurology | | | 0 | |
| 5a | 99.29 | Administer t-PA (Inject | 91015 | 7989 | 727118835 | 0 |
| | | other) | | | | |
| 5b | 89.15 | Neurologic Exam | 1194 | 8312 | 9924528 | 0 |
| 5c | 89.54 | Admit to ICU, | 153987 | 5487 | 844926669 | 0 |
| | | Heart/Respiration | | | | |
| | | Monitor | | | | |
| 5d | 89.15 | Neurologic Exam | 1194 | 8312 | 9924528 | 0 |
| 5d | 88.72 | Echo Cardiogram | 246547 | 7859 | 1937612873 | 0 |
| 5d | 88.71 | Carotid Ultrasound | 31001 | 8217 | 254735217 | 0 |
| 5d | 88.41 | Arteriogram | 34518 | 10414 | 359470452 | 0 |
| 5d | 99.18 | IV Fluids | 7752 | 4304 | 33364608 | 0 |
| 5d | 99.19 | Anticoagulants | 20041 | 8161 | 163554601 | 0 |
| 5d | Total | Admit to Stroke Unit | 341053 | | 2758662279 | |
| 5e | 93.39 | Physical Therapy | 91820 | 12271 | 1126723220 | 0 |
| 5e | 93.83 | Occupational Therapy | 30886 | 9082 | 280506652 | 0 |
| 5e | Total | | 122706 | | 1407229872 | |
| 5f | N/A | Discharge | | | 0 | |
| 5 | Total | t-PA Therapy | 709955 | | 5747862183 | |
| 6 | 89.15 | Neurologic Exam | 1194 | 8312 | 9924528 | 0 |
| 6 | 88.72 | Echo Cardiogram | 246547 | 7859 | 1937612873 | 0 |
| 6 | 88.71 | Carotid Ultrasound | 31001 | 8217 | 254735217 | 0 |
| 6 | 99.18 | IV Fluids | 7752 | 4304 | 33364608 | 0 |
| 6 | 89.52 | EKG | 33111 | 5940 | 196679340 | 0 |
| 6 | 89.54 | Heart Monitor | 153987 | 5487 | 844926669 | 0 |
| 6 | Total | Admit to Stroke Unit | 473592 | | 3277243235 | |
| 7 | 99.19 | Anticoagulants | 20041 | 8161 | 163554601 | 0 |
| 8 | 88.41 | Cerebral Angiogram | 34518 | 10414 | 359470452 | 0 |
| 8 | 88.91 | MRI/MRA | 61112 | 8501 | 519513112 | 0 |
| 8 | Total | Evaluate Vasculature | 95630 | | 878983564 | |
| 9 | 38.12 | Carotid Endarterectomy | 91669 | 12260 | 1123861940 | 0 |
| 9 | 99.19 | Anticoagulants | 20041 | 8161 | 163554601 | 0 |
| 10 | N/A | Bed Rest | | | | |
| 11 | 93.39 | Physical Therapy | 91820 | 12271 | 1126723220 | 0 |
| 11 | 93.83 | Occupational Therapy | 30886 | 9082 | 280506652 | 0 |
| 11 | Total | | 122706 | | 1407229872 | |
| 12 | N/A | Discharge | | | 0 | |

Using information from step 100 combined with personal knowledge, select a node in the pathway for more detailed study (step 102). In the above example, since the node “Administer t-PA” (step 90) is comprised of many sub-nodes and has a potential total cost of more than $5 billion, the use of t-PA in the treatment of stroke was chosen. Additionally, the t-PA treatment is newly approved for stroke, so there may be opportunities for HPMS to exploit early in the life of the treatment.

Clinicians or other experts are contacted again to map the selected clinical pathway node in high detail so that the relationships between treatments and branches may be understood based on relative severity or variations in the selected Disease state (step 104).

Once the details in the selected pathway node are sufficiently understood (step 104), the user must make creative and intuitive leaps to generate a list of projected customer problems, then needs (i.e., what HPMS believes customers need) (step 106). The basic question which must be answered by wallowing is, “how can the customer be assisted in treatment of this condition, either in reducing the cost or improving the outcome?” One way this can be done is by an intervention in the Pathway which shortens or eliminates sections of the treatment map. In the illustrated embodiment, the needs identified by wallowing were:

1. To be able to measure the passage of time since the stroke occurred.

Since t-PA treatment requires that it be less than three hours since the onset of the stroke (otherwise there is risk of massive bleeding), for clinician to have an accurate measure of the time since the stroke began would allow them to administer t-PA to a potential 20% increase in patients. According to the contact clinician, about 20% of patients cannot have t-PA treatment because the time since Stroke onset is unknown.

2. To be able to test for whether a stroke is occlusive or hemorrhagic.

Occlusive and Hemorrhagic Strokes have completely different Clinical Pathways. Most of this investigation focuses on Occlusive Stroke, and t-PA treatment is for Occlusive Stroke exclusively. Clinicians are able to determine that a Stroke is Hemorrhagic using a CAT scan, but rely on patient observation and deduction to determine that a Stroke is Occlusive. Consequently, a significant amount of time is wasted to examine Occlusive Stroke victims using the CAT scan (sometimes more than one hour). One of the critical factors for t-PA is time, so to be able to determine what type of Stroke has occurred (Occlusive or Hemorrhagic) quickly in the Emergency Room, could reduce examination time and significantly improve outcomes for patients.

After customer needs are projected (step 106), it is necessary to qualify them with actual customers (step 108). Using some of the primary research contacts from previous steps, the user must assess the validity of the needs and their relative importance to the customer.

In the illustrated embodiment, the projected customer needs were explained to the clinician, who agreed that solving the problems described by the needs would improve his ability to treat patients, and could significantly improve patient outcomes. Normally, more than one clinician should be contacted throughout the process to increase the sample size of the investigation. For the purpose of this exemplary investigation, resources and time were limited, so clinician contact was based on a personal relationship. Other sources of primary research described in previous sections should be explored.

Once needs are validated and ranked in importance to the customer (step 108), check to confirm that the needs are well-defined (step 110). Well-defined needs refer to one or more specific treatment procedures and focus on costs of treatments or on patient outcomes (or both). In the illustrated embodiment, the goal of each of the qualified needs is to improve the outcome of patient treatment. At the same time, the needs eliminate or shorten branches in the clinical pathway, which reduces cost. The needs in the illustrated embodiment therefore are well-defined.

If it is determined that the needs are not well-defined (step 110), return to step 106 and continue the wallowing process to refine the needs assessment. If the needs are not attractive (step 112), store them in an Idea Bank for later review and end the process (steps 116 and 118).

Well-defined needs should be attractive to HPMS and MPG according to core competencies (MC²) and resources. In other words, for the first time in the scanning process, the needs are viewed in the HP context. The needs must be attractive to HPMS and MPG to advance to the next step. Attractiveness is defined above as matching with HP's core competencies (MC²) and resources. Each of the defined needs is easily aligned with Measurement and Computation (potentially even as an I-stat product) and could be adapted to a Communications environment, depending on the target market. Additionally, each of the needs falls into a well-developed MPG market, where channels and resources are already in place. The needs are attractive, and HPMS Pre-phase 0 should be initiated.

If the needs appear to be attractive (step 112), begin HPMS Pre-phase 0 of the Phase Review Process (step 114).

V. Conclusion

In sum, the above-described methods enable new business and product opportunities to be identified, particularly in areas in which an entity may not have significant prior experience. It creates the opportunity to find business opportunities in areas that are “New Markets” as well as those that are new to the entity employing this process. These methods provide a systematic way to explore markets without prejudice, and to understand customer needs from the outset.

The systems and methods described herein are not limited to any particular hardware or software configuration, but rather they may be implemented in any computing or processing environment, including in digital electronic circuitry or in computer hardware, firmware or software. The various processing modules may be implemented, in part, in a computer program product tangibly embodied in a machine-readable storage device for execution by a computer processor. In some embodiments, these modules preferably are implemented in a high level procedural or object oriented programming language; however, the algorithms may be implemented in assembly or machine language, if desired. In any case, the programming language may be a compiled or interpreted language. The video input segmentation methods described herein may be performed by a computer processor executing instructions organized, e.g., into program modules to carry out these methods by operating on input data and generating output. Suitable processors include, e.g., both general and special purpose microprocessors. Generally, a processor receives instructions and data from a read-only memory and/or a random access memory. Storage devices suitable for tangibly embodying computer program instructions include all forms of non-volatile memory, including, e.g., semiconductor memory devices, such as EPROM, EEPROM, and flash memory devices; magnetic disks such as internal hard disks and removable disks; magneto-optical disks; and CD-ROM. Any of the foregoing technologies may be supplemented by or incorporated in specially-designed ASICs (application-specific integrated circuits).

Other embodiments are within the scope of the claims.

What is claimed is:

1. A method of identifying potential business opportunities, comprising:
identifying a target customer need state based upon an analysis of marketplace data;
generating a map of a process for addressing the identified target customer need state, the process map including a network of tasks each having one or more associated values; and
identifying a potential point of intervention in the process based at least in part upon an analysis of the values associated with the tasks in the process map.

2. The method of claim 1, wherein identifying a target customer need state comprises scanning marketplace data without foreknowledge of a potential target customer need state.

3. The method of claim 1, wherein identifying a target customer need state comprises scanning marketplace data in accordance with a preselected target customer need state.

4. The method of claim 1, wherein the identified target customer need state corresponds to a customer need state associated with a relatively high total cost.

5. The method of claim 1, wherein identifying a target customer need state comprises selecting a subset of potential target customer need states and associating with each potential target customer need state a set of one or more tasks.

6. The method of claim 5, further comprising assigning values to the tasks associated with each of the potential target customer need states.

7. The method of claim 6, wherein values for one or more of the following task parameter metrics are assigned to the associated tasks: a cost metric, an incidence rate metric, and a metric measuring diversity of association with different potential target customer need states.

8. The method of claim 7, further comprising ranking potential target customer need states in accordance with values assigned to associated tasks.

9. The method of claim 1, wherein generating a map of a process for addressing the identified target customer need state comprises identifying a representative process currently addressing the identified target customer need state and generating a map for the representative process.

10. The method of claim 9, further comprising estimating unit cost values, incidence rates, total costs, and outcomes for each task in the process map generated for the representative process.

11. The method of claim 10, wherein identifying a potential point of intervention comprises selecting a potential target task from the tasks in the representative process map based at least in part upon one or more of the estimated unit cost values, incidence rates, total costs, and outcomes.

12. The method of claim 11, further comprising mapping the potential target task into a network of one or more sub-tasks.

13. The method of claim 12, further comprising generating a list of one or more projected customer problems based at least in part upon the potential target task mapping.

14. The method of claim 13, further comprising generating a list of one or more projected customer needs based at least in part upon the projected customer problem list.

15. The method of claim 14, wherein generating the projected customer needs list comprises identifying customer needs that correspond to business opportunities for reducing cost or improving outcomes, or both.

16. The method of claim 14, further comprising assessing customer value associated with each of the projected customer needs.

17. The method of claim 14, wherein generating the projected customer needs list comprises identifying customer needs associated with specific tasks and focused on reducing cost or improving outcomes, or both.

18. The method of claim 14, further comprising correlating projected customer needs with core competencies and resources.

19. The method of claim 18, further comprising selecting for further investigation one or more target projected customer needs well-correlated with core competencies and resources.

20. The method of claim 19, further comprising storing for later review unselected target projected customer needs.
